(19) United States
(12) Patent Application Publication
(10) Pub. No.: US 2025/0150765 A1
(43) Pub. Date: May 8, 2025

(54) CONTROL DEVICE, HEARING AID, CHARGING DEVICE, HEARING AID SYSTEM, PROGRAM, AND CONTROL METHOD

(71) Applicant: Sony Group Corporation, Tokyo (JP)

(72) Inventors: Tomoko TERAKADO, Kanagawa (JP); Koji OKUMOTO, Tokyo (JP); Ryu SUKIGARA, Kanagawa (JP)

(73) Assignee: Sony Group Corporation, Tokyo (JP)

(21) Appl. No.: 18/837,613

(22) PCT Filed: Jan. 26, 2023
(86) PCT No.: PCT/JP2023/002370

§ 371 Date: Aug. 12, 2024

(30) Foreign Application Priority Data
Mar. 4, 2022 (JP) 2022-033666

(51) Int. Cl. H04R 25/00

(52) U.S. Cl. CPC H04R 25/305; H04R 25/70; H04R 2225/31

(57) ABSTRACT

A control device includes: an acquisition unit that acquires sound pressure information and a use time, the sound pressure information being information regarding a sound to be output from a hearing aid to a predetermined user, the use time being time during which the predetermined user has used the hearing aid; and a setting unit that sets a parameter of the hearing aid in an auditory rehabilitation plan of the predetermined user based on the sound pressure information and the use time.

### FIELD

The present disclosure relates to a control device, a hearing aid, a charging device, a hearing aid system, a program, and a control method.

### BACKGROUND

In recent years, there is a hearing aid known as an Over-the-Counter (OTC) hearing aid that can be purchased by a patient without a need of fitting adjustment by a doctor or a health care professional. When using such an OTC hearing aid, the patient themselves performs fitting adjustment on the patient performed by a doctor or a health care professional such as an audiologist, which has been performed in the conventional hearing aid, making it difficult to adjust hearing suitable for the patient. This has led to a possibility of discontinuation of use of the hearing aid by the patient. To handle this, Patent Literature 1 discloses a technique in which the performance of a hearing aid automatically changes from an initial parameter to a final parameter designed to perform optimal compensation of the auditory disorder of the patient with the lapse of the operating time.

### CITATION LIST

### Patent Literature

Patent Literature 1: U.S. Patent Application Publication No. 2003/0215105

### SUMMARY

### Technical Problem

Meanwhile, a patient who cannot feel the effect of the hearing aid might discontinue use of the hearing aid due to inappropriate adjustment.

However, the technique in Patent Literature 1 merely changes the parameter of the performance of the hearing aid with the lapse of the operating time of the hearing aid without any consideration of use situations of the hearing aid, having a problem of difficulty setting an optimal parameter of the hearing aid for each user.

The present disclosure has been made in view of the above, and aims to provide a control device, a hearing aid, a charging device, a hearing aid system, a program, and a control method capable of setting an optimal parameter of the hearing aid for each user.

### Solution to Problem

In order to solve the above problems, a control device according to an embodiment of the present disclosure includes an acquisition unit that acquires sound pressure information and use time, the sound pressure information being information regarding a sound to be output from a hearing aid to a predetermined user, the use time being a time during which the predetermined user has used the hearing aid; and a setting unit that sets a parameter of the hearing aid in an auditory rehabilitation plan of the predetermined user based on the sound pressure information and the use time.

Also, a control device according to an embodiment of the present disclosure includes: an acquisition unit that acquires a use time during which a predetermined user has used a hearing aid and a use situation of the hearing aid; and a setting unit that sets a parameter of the hearing aid in an auditory rehabilitation plan of the predetermined user based on the use time and the use situation.

Also, A hearing aid according to an embodiment of the present disclosure includes: the control device for the above disclosure; a sound collection unit that collects an external sound and generates an audio signal; a signal processing unit that amplifies the audio signal; and an output unit that outputs a sound corresponding to the audio signal amplified by the signal processing unit, wherein the setting unit sets a gain applied by the signal processing unit for the audio signal, as the parameter.

Also, a charging device to an embodiment of the present disclosure includes: the control device for the above disclosure; and a housing capable of housing the hearing aid and configured to charge the hearing aid.

Also, a hearing aid system the control device for the above disclosure: a hearing aid that can be worn by a predetermined user; a charging device capable of housing the hearing aid and capable of charging the hearing aid; a communication device that is communicable with at least either one of the hearing aid or the charging device and generates auditory rehabilitation plan data of the predetermined user and outputs the generated auditory rehabilitation plan data to either the hearing aid or the charging device; and a control device that controls performance of the hearing aid, wherein the control device is provided in any of the hearing aid, the charging device, and the communication device, and the control device includes: an acquisition unit that acquires sound pressure information and a use time, the sound pressure information being information regarding a sound to be output from the hearing aid to the predetermined user, the use time being a time during which the predetermined user has used the hearing aid; and a setting unit that sets a parameter of the hearing aid in an auditory rehabilitation plan of the predetermined user based on the sound pressure information and the use time.

Also, a program to be executed by a control device, the control device including a processor and configured to control performance of a hearing aid, the program causing the processor to execute processing including: acquiring sound pressure information and use time, the sound pressure information being information regarding a sound to be output from the hearing aid to a predetermined user, the use time being a time during which the predetermined user has used the hearing aid; and setting a parameter of the hearing aid in an auditory rehabilitation plan of the predetermined user based on the sound pressure information and the use time.

Also, a control method to be executed by a control device, the control device including a processor and configured to control performance of a hearing aid, the method comprising: by the processor, acquiring sound pressure information and use time, the sound pressure information being information regarding a sound to be output from the hearing aid to a predetermined user, the use time being a time during which the predetermined user has used the hearing aid; and setting a parameter of the hearing aid in an auditory rehabilitation plan of the predetermined user based on the sound pressure information and the use time.

### BRIEF DESCRIPTION OF DRAWINGS

FIG. 1 is a diagram illustrating a schematic configuration of a hearing aid system according to a first embodiment.

FIG. 2 is a block diagram illustrating a functional configuration of a hearing aid system according to a first embodiment.

FIG. 3 is a diagram schematically illustrating an outline of an auditory rehabilitation plan using a conventional model.

FIG. 4 is a diagram schematically illustrating an outline of an audiogram using a conventional model.

FIG. 5 is a flowchart illustrating an outline of processing executed by a hearing aid according to the first embodiment.

FIG. 6 is a flowchart illustrating details of initial setting processing in FIG. 5.

FIG. 7 is a block diagram illustrating a functional configuration of the hearing aid system according to the second embodiment.

FIG. 8 is a flowchart illustrating an outline of processing executed by a hearing aid according to the second embodiment.

FIG. 9 is a block diagram illustrating a functional configuration of a hearing aid system according to a third embodiment.

FIG. 10 is a flowchart illustrating an outline of processing executed by a charging device according to the third embodiment.

FIG. 11 is a diagram illustrating a schematic configuration of a hearing aid system according to a modification of the first to third embodiments.

### DESCRIPTION OF EMBODIMENTS

Hereinafter, modes for carrying out the present disclosure will be described in detail with reference to the drawings. Note that the present disclosure is not limited to the following embodiments. In addition, each drawing referred to in the following description merely schematically illustrates a shape, a size, and a positional relationship to an extent to facilitate understanding of the content of the present disclosure. That is, the present disclosure is not limited only to the shape, size, or positional relationship illustrated in each drawing. Furthermore, in the description of the drawings, the same portions will be denoted by the same reference numerals. Furthermore, as an example of the hearing aid system according to the present disclosure, a hearing aid system including a pair of left and right in-ear type air conduction hearing aids will be described.

### First Embodiment

### [Outline of Hearing Aid System]

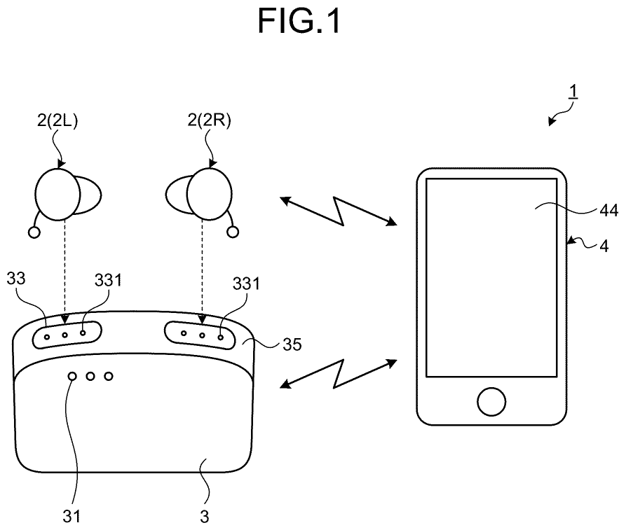

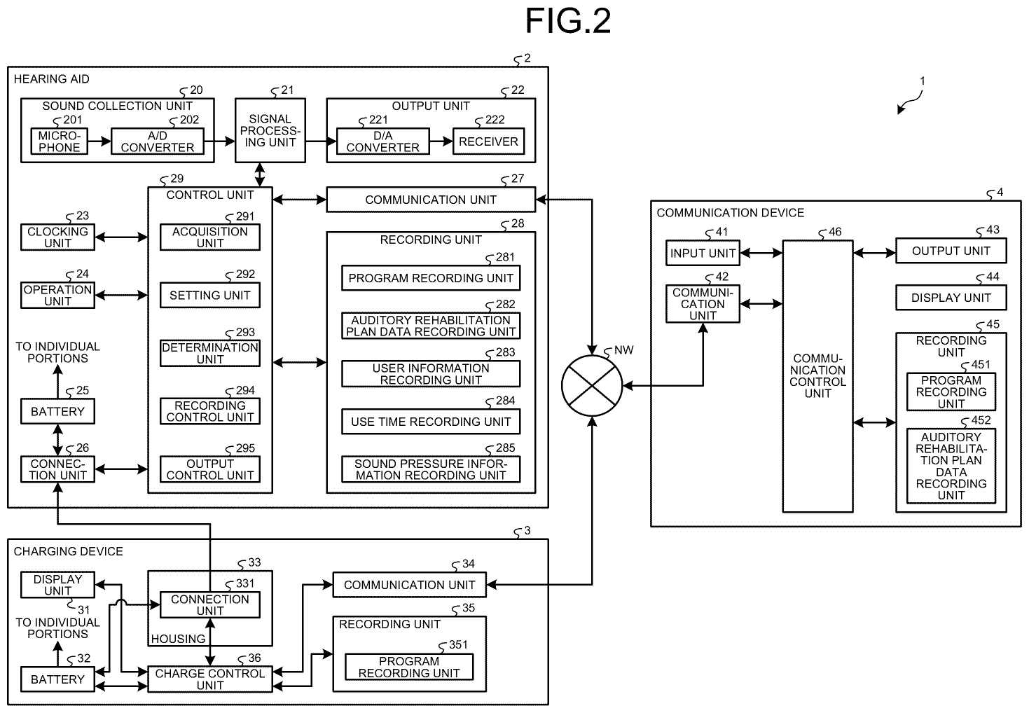

FIG. 1 is a diagram illustrating a schematic configuration of a hearing aid system according to a first embodiment. FIG. 2 is a block diagram illustrating a functional configuration of the hearing aid system according to the first embodiment.

A hearing aid system 1 illustrated in FIGS. 1 and 2 includes: a pair of left and right hearing aids 2; a charging device 3 (charging case) that houses the hearing aid 2 and charges the hearing aid 2; and a communication device 4 such as a mobile phone capable of communicating with at least either one of the hearing aid 2 or the charging device 3.

The first embodiment will describe a case where the hearing aid 2 is of the air conduction hearing aid. However, the type is not limited thereto, and the technique is also applicable to a bone conduction hearing aid. Furthermore, the first embodiment will describe a case where the hearing aid 2 is an in-ear hearing aid. However, the type is not limited thereto, and the technique is also applicable to a behind-the-ear, a headphone type, or a body type hearing aid. Furthermore, the first embodiment will describe a case where the hearing aid 2 is a binaural type. However, the type is not limited thereto, and the technique is also applicable to a single ear type hearing aid to be worn on one of the left and right. In the following description, the hearing aid 2 to be worn on the right ear is referred to as a hearing aid 2R, the hearing aid 2 to be worn on the left ear is referred to as a hearing aid 2L, and either one of the left-right pair is simply referred to as the hearing aid 2.

### [Configuration of Hearing Aid]

First, a configuration of the hearing aid 2 will be described.

As illustrated in FIGS. 1 and 2, the hearing aid 2 includes a sound collection unit 20, a signal processing unit 21, an output unit 22, a clocking unit 23, an operation unit 24, a battery 25, a connection unit 26, a communication unit 27, a recording unit 28, and a control unit 29.

The sound collection unit 20 includes a microphone 201 and an A/D converter 202. The microphone 201 collects external sound, generates an analog audio signal (acoustic signal), and outputs the generated analog audio signal to the A/D converter 202. The A/D converter 202 performs A/D conversion processing on the analog audio signal input from the microphone 201 and outputs an obtained digital audio signal to the signal processing unit 21.

Under the control of the control unit 29, the signal processing unit 21 performs predetermined signal processing on the digital audio signal input from the sound collection unit 20, and outputs the obtained digital audio signal to the output unit 22. Here, the predetermined signal processing includes filtering processing of separating an audio signal into each predetermined frequency, amplification processing of amplifying the audio signal with a predetermined amplification level for each predetermined frequency subjected to the filtering processing, noise reduction processing, and howling cancellation processing. The signal processing unit 21 includes memory and a processor having hardware devices such as a digital signal processor (DSP).

The output unit 22 includes a D/A converter 221 and a receiver 222. The D/A converter 221 performs D/A conversion processing on the digital audio signal input from the signal processing unit 21 and outputs the obtained digital audio signal to the receiver 222. The receiver 222 outputs an output sound (audio) corresponding to the analog audio signal input from the D/A converter 221. The receiver 222 is constituted with a speaker or the like, for example.

The clocking unit 23 clocks the date and time and outputs a result of the clocking to the control unit 29. The clocking unit 23 is constituted with a timing generator, a timer having a clocking function, or the like.

The operation unit 24 receives an input of an activation signal for activating the hearing aid 2 and outputs the received activation signal to the control unit 29. The operation unit 24 is constituted with a push switch, a button, a touch panel, or the like.

The battery 25 supplies power to individual portions constituting the hearing aid 2. The battery 25 is constituted with a rechargeable secondary battery, for example, a lithium ion battery. The battery 25 is charged by power supplied from the charging device 3 via the connection unit 26.

When the hearing aid 2 is housed in the charging device 3 described below, the connection unit 26 is connected to a connection unit of the charging device 3, receives power and various types of information from the charging device 3, and outputs various types of information to the charging device 3. The connection unit 26 is constituted with a plurality of pins.

Under the control of the control unit 29, the communication unit 27 bidirectionally communicates with the charging device 3 or the communication device 4 in accordance with a predetermined communication standard via a network NW. Here, examples of the conceivable predetermined communication standard include Wi-Fi (registered trademark) and Bluetooth (registered trademark). The communication unit 27 is constituted with a communication module or the like.

The recording unit 28 records various types of information related to the hearing aid 2. The recording unit 28 includes random access memory (RAM), read only memory (ROM), and a memory card. The recording unit 28 includes a program recording unit 281, an auditory rehabilitation plan data recording unit 282, a user information recording unit 283, a use time recording unit 284, and a sound pressure information recording unit 285.

The program recording unit 281 records the program to be executed by the hearing aid 2 and various types of data being processed by the hearing aid 2.

The auditory rehabilitation plan data recording unit 282 records auditory rehabilitation plan data corresponding to an auditory rehabilitation plan of the user. Here, the auditory rehabilitation plan data is data that sets the hearing level every predetermined period toward the target hearing level of the user. The auditory rehabilitation plan data is generated by the communication device 4 to be described below.

The user information recording unit 283 records information such as the age of the user, the presence or absence of use experience of the hearing aid 2 of the user, and the gender of the user.

Under the control of the control unit 29, the use time recording unit 284 accumulates and records a use time during which the user has used the hearing aid 2 clocked by the clocking unit 23. In addition to the use time, the use time recording unit 284 may record a data log of the use situation of the hearing aid 2, the use sound environment of the hearing aid 2, and the like.

Under the control of the control unit 29, the sound pressure information recording unit 285 records the sound pressure information, being information regarding a sound to be output from the output unit 22 to the user. Here, the sound pressure information represents the magnitude of an output sound (sound pressure level) corresponding to an output signal for the signal processing unit 21 to output an audio signal, which has been generated by the hearing aid 2 collecting the external sound, after being adjusted to the hearing level of the user according to the auditory rehabilitation plan. In addition, the magnitude of the output sound corresponds to one of: the time (integrated value) accumulated for each frequency and each sound pressure level; and sound pressure level integrated time (integrated value) obtained by combining a sum for each frequency and a sum for each sound pressure level. Specifically, the time for each sound pressure level for each frequency is an accumulation time (total time) of outputting individual sound pressure levels 60 dB, 70 dB, and 80 dB, for example, when the signal at each frequency 500 Hz, 750 Hz, 1000 Hz, 2000 Hz, 3000 Hz, 4000 Hz, 6000 Hz, and 8000 Hz (in a case where the frequency is eight bands) is amplified and output by the signal processing unit 21. In addition, the sound pressure level time obtained by combining the sum for each frequency and the sum for each sound pressure level is an accumulation time (total time) of outputting the sound pressure level obtained by combining the sum, for each sound pressure level, when the signal at each frequency 500 Hz, 750 Hz, 1000 Hz, 2000 Hz, 3000 Hz, 4000 Hz, 6000 Hz, and 8000 Hz (in a case where the frequency is eight bands) is amplified and output.

The control unit 29 controls individual portions constituting the hearing aid 2. The control unit 29 is constituted with memory and a processor having hardware devices such as a central processing unit (CPU) and a DSP. The control unit 29 reads a program recorded in the program recording unit 281 onto the work area of the memory so as to execute the program, and controls each component and the like through the execution of the program by the processor, leading to cooperation of the hardware and the software to implement functional modules suitable for predetermined purposes.

Specifically, the control unit 29 includes an acquisition unit 291, a setting unit 292, a determination unit 293, a recording control unit 294, and an output control unit 295. In the first embodiment, the control unit 29 functions as a control device.

The acquisition unit 291 acquires: sound pressure information, being information regarding the sound to be output from the hearing aid 2 to the user recorded by the sound pressure information recording unit 285; and the use time, being the time during which the user has used the hearing aid 2 recorded by the use time recording unit 284.

The setting unit 292 sets a parameter of the hearing aid 2 based on the sound pressure information and the use time acquired by the acquisition unit 291.

The determination unit 293 determines whether the user has worn the hearing aid 2. In addition, the determination unit 293 determines whether the use time of the user's hearing aid 2 recorded by the use time recording unit 284 is a predetermined time or more. Here, the predetermined time is a time set for each predetermined period in the auditory rehabilitation plan data. In addition, the determination unit 293 determines whether the sound pressure information recorded by the sound pressure information recording unit 285 indicates a predetermined sound pressure level or more. Specifically, the determination unit 293 determines whether 30% or more of the sound pressure information recorded by the sound pressure information recording unit 285 indicates a sound pressure level of 60 dB or more.

The recording control unit 294 controls the recording for accumulating (clocking) the time clocked by the clocking unit 23 in the use time recording unit 284 as the use time and the recording for accumulating sound pressure information regarding the sound to be output from the output unit 22 to the user in the sound pressure information recording unit 285.

The output control unit 295 outputs, to the charging device 3 or the communication device 4, initial setting completion information indicating completion of the initial setting for generating the auditory rehabilitation plan data and recording the generated data in the hearing aid 2.

### [Configuration of Charging Device]

Next, the configuration of the charging device 3 will be described.

As illustrated in FIGS. 1 and 2, the charging device 3 includes a display unit 31, a battery 32, a housing 33, a communication unit 34, a recording unit 35, and a charge control unit 36.

The display unit 31 displays various states related to the hearing aid 2 under the control of the charge control unit 36. For example, the display unit 31 displays information indicating that the hearing aid 2 is being charged and information indicating that various types of information are being received from the communication device 4. The display unit 31 is constituted with a light emitting diode (LED) or the like.

The battery 32 supplies power to the hearing aid 2 housed in the housing 33 and individual portions constituting the charging device 3 via a connection unit 331 (described below) provided in the housing 33. The battery 32 is constituted with a secondary battery, specifically, a lithium ion battery, for example. In the first embodiment, in addition to the battery 32, it is also allowable to provide a power supply circuit that supplies power to the hearing aid 2 by first converting AC power supplied from the outside into DC power and then converting the DC power into a predetermined voltage by DC/DC conversion.

The housing 33 individually houses the left and right hearing aids 2. In addition, the housing 33 has a connection unit 331 connectable to the connection unit 26 of the hearing aid 2.

When the hearing aid 2 is housed in the housing 33, the connection unit 331 is connected to the connection unit 26 of the hearing aid 2, transmits power from the battery 32 and various types of information from the charge control unit 36, and receives various types of information from the hearing aid 2 so as to be output to the charge control unit 36. The connection unit 331 is constituted with a plurality of pins.

Under the control of the charge control unit 36, the communication unit 34 communicates with the communication device 4 in accordance with a predetermined communication standard via the network NW. The communication unit 34 is constituted with a communication module.

The recording unit 35 includes a program recording unit 351 that records various programs to be executed by the charging device 3. The recording unit 35 includes RAM, ROM, flash memory, a memory card, and the like.

The charge control unit 36 controls individual portions constituting the charging device 3. For example, when the hearing aid 2 is housed in the housing 33, the charge control unit 36 controls to supply power from the battery 32 via the connection unit 331. The charge control unit 36 is constituted with a memory and a processor having hardware devices such as a CPU or a DSP. The charge control unit 36 reads a program recorded in the program recording unit 351 onto the work area of the memory so as to execute the program, and controls each component and the like through the execution of the program by the processor, leading to cooperation of the hardware and the software to implement functional modules suitable for predetermined purposes.

### [Configuration of Communication Device]

Next, a configuration of the communication device 4 will be described.

As illustrated in FIGS. 1 and 2, the communication device 4 includes an input unit 41, a communication unit 42, an output unit 43, a display unit 44, a recording unit 45, and a communication control unit 46.

The input unit 41 receives inputs of various operations from the user, and outputs a signal corresponding to the received operation to the communication control unit 46. The input unit 41 is constituted with a switch, a touch panel, and the like.

The communication unit 42 communicates with the charging device 3 or the hearing aid 2 via the network NW under the control of the communication control unit 46. The communication unit 42 is constituted with a communication module.

The output unit 43 outputs a sound having a volume of a predetermined sound pressure level for each predetermined frequency under the control of the communication control unit 46. The output unit 43 is constituted with a speaker or the like.

The display unit 44 displays various types of information regarding the communication device 4 and information regarding the hearing aid 2 under the control of the communication control unit 46. The display unit 44 includes a liquid crystal display, an organic electroluminescent display (EL display), or the like.

The recording unit 45 records various types of information regarding the communication device 4. The recording unit 45 includes: a program recording unit 451 that records various programs to be executed by the communication device 4; and an auditory rehabilitation plan data recording unit 452 that records auditory rehabilitation plan data. The recording unit 45 is constituted with a recording medium such as RAM, ROM, flash memory, or a memory card.

The communication control unit 46 controls individual portions constituting the communication device 4. The communication control unit 46 includes memory and a processor having hardware devices such as a CPU. The communication control unit 46 reads a program recorded in the program recording unit 451 onto the work area of the memory so as to execute the program, and controls each component and the like through the execution of the program by the processor, leading to cooperation of the hardware and the software to implement functional modules suitable for predetermined purposes.

### [Auditory Rehabilitation]

Next, auditory rehabilitation using a conventional hearing aid (hereinafter, referred to as “conventional model”) will be described.

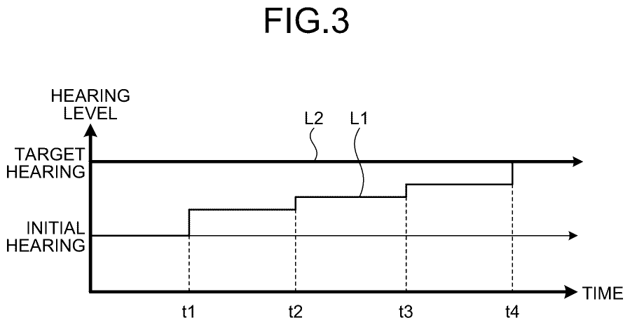

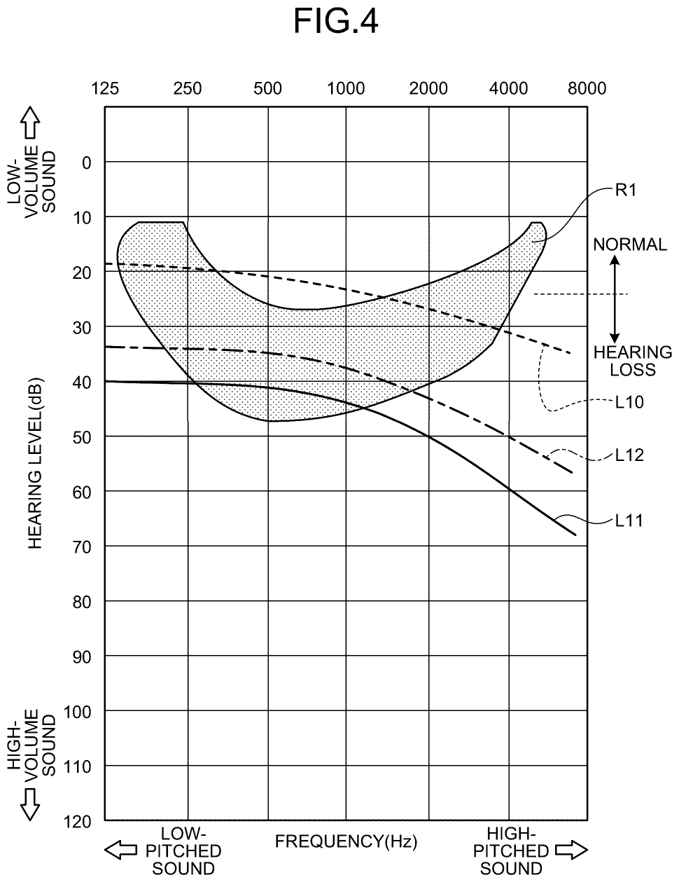

FIG. 3 is a diagram schematically illustrating an outline of an auditory rehabilitation plan using a conventional model. FIG. 4 is a diagram schematically illustrating an outline of an audiogram (hearing chart) using a conventional model. In FIG. 3, the horizontal axis represents time, and the vertical axis represents the hearing level (dB). In addition, a polygonal line L1 indicates the relationship between the time and the hearing level of the auditory rehabilitation plan regarding a person with hearing loss who uses the conventional model for the first time. A straight line L2 indicates the target hearing level (dB). Further, in FIG. 4, the horizontal axis represents frequency, and the vertical axis represents the hearing level (dB). Furthermore, in FIG. 4, a curve L10 indicates the target hearing level (dB), a curve L11 indicates the hearing level of the user before wearing the conventional model, and a curve L12 indicates the hearing level (dB) when the user wears the conventional model for the first time. Furthermore, a region R1 in FIG. 4 is a conversation area (speech banana).

As indicated by the curve L11 in FIG. 4, in a case where the user with hearing loss uses the conventional model for the first time, giving the sound with a volume of the target hearing level indicated by the straight line L2 in FIG. 3 and the curve L10 in FIG. 4 from the beginning to the brain of the user with hearing loss, which has been accustomed to the state of no sound, will make the user hear a sound that is supposed to be inaudible. As a result, the user with hearing loss feels noisy and very uncomfortable when hearing a sound supposed to be inaudible.

To handle this, as indicated by a curve L12 in FIG. 4, the conventional auditory rehabilitation starts with a predetermined value, for example, 80% of the target hearing level. Furthermore, in the conventional auditory rehabilitation, the volume according to the hearing level of the user is increased stepwise every predetermined time (from time t1 to time t4) indicated by the polygonal line L1 in FIG. 3 over a predetermined period, for example, two to three months, so that the sound is acclimated to the brain to reach the target hearing level.

In this conventional auditory rehabilitation, it has been necessary for the user to adjust a conventional model in a hospital or the like under the health care professional to create an auditory rehabilitation plan. Furthermore, the user who cannot feel the effect of the hearing aid 2 has been led to the discontinuation of use of the conventional model due to inappropriate adjustment of the conventional model.

In addition, the health care professional conducts an interview about the use situation of the person with hearing loss, thereby adjusting the conventional model. However, there may be a deviation between the actual use environment and the use situation obtained by the interview. Furthermore, there has been a problem that the health care professional cannot accurately create the auditory rehabilitation plan only with the chronological record of use time of the conventional model.

Therefore, the control unit 29 of the hearing aid 2 acquires: sound pressure information, being information regarding the sound to be output from the hearing aid 2 to a predetermined user; and a use time, being the time during which the predetermined user has used the hearing aid 2, and sets the parameter of the hearing aid 2 in the auditory rehabilitation plan of the predetermined user based on the acquired sound pressure information and the use time. That is, the control unit 29 of the hearing aid 2 sets the current sound volume (sound pressure level) and the period of the current sound volume as parameters of the hearing aid 2 in the auditory rehabilitation plan of the predetermined user based on the sound pressure information regarding the sound to be output from the hearing aid 2 to the predetermined user and based on the use time during which the predetermined user has used the hearing aid 2, enabling parameter setting for the hearing aid 2 optimal for the user.

### [Processing of Hearing Aid]

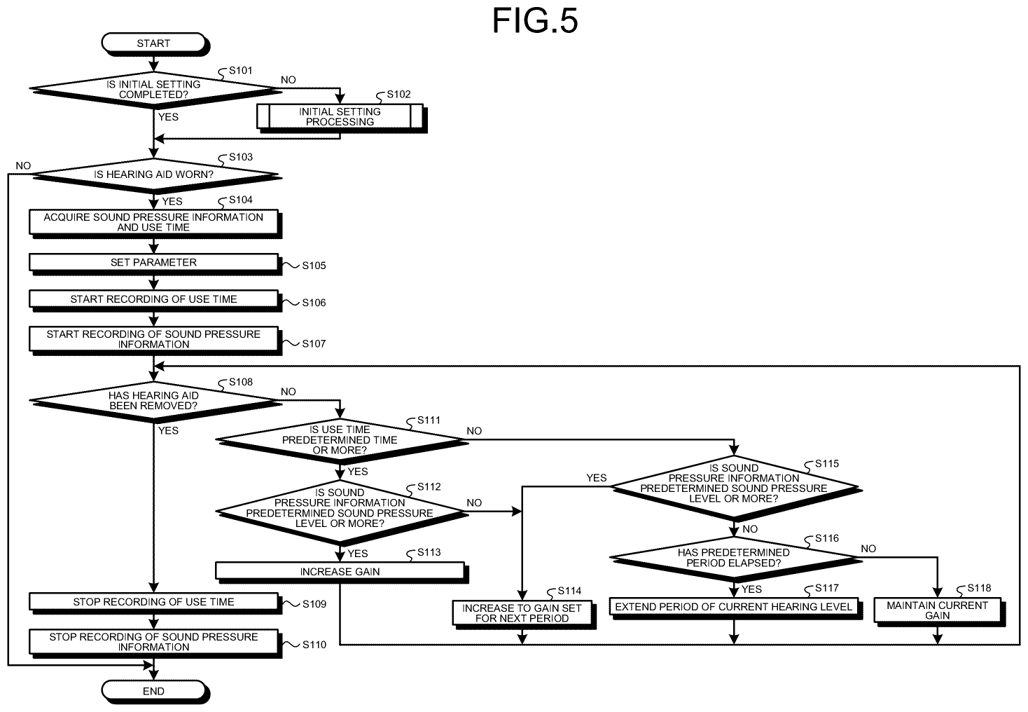

Next, processing executed by the hearing aid 2 will be described. FIG. 5 is a flowchart illustrating an outline of processing executed by the hearing aid 2.

As illustrated in FIG. 5, the determination unit 293 first determines whether the user has completed the initial setting of the auditory rehabilitation of the hearing aid 2 (step S101). Specifically, the determination unit 293 determines whether the auditory rehabilitation plan data set for the user is recorded in the auditory rehabilitation plan data recording unit 282. In a case where the auditory rehabilitation plan data is not recorded, the determination unit 293 determines that the user has not completed the initial setting of the auditory rehabilitation of the hearing aid 2. When the determination unit 293 has determined that the user has completed the initial setting of the auditory rehabilitation of the hearing aid 2 (step S101: Yes), processing of the hearing aid 2 proceeds to step S103 described below. In contrast, when the determination unit 293 has determined that the user has not completed the initial setting of the auditory rehabilitation of the hearing aid 2 (step S101: No), processing of the hearing aid 2 proceeds to step S102 described below.

In step S102, the hearing aid 2 executes initial setting processing of acquiring the auditory rehabilitation plan data of the user via the communication device 4.

### [Outline of Initial Setting Processing]

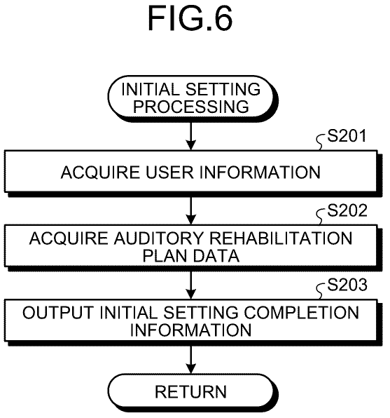

FIG. 6 is a flowchart illustrating details of the initial setting processing in step S102 of FIG. 5.

As illustrated in FIG. 6, as a first step, the output control unit 295 is connected to the communication device 4 via the communication unit 27, and outputs the user information recorded by the user information recording unit 283 to the communication device 4 (step S201).

Subsequently, the acquisition unit 291 acquires the auditory rehabilitation plan data generated by the communication device 4 via the communication unit 27 and records the acquired auditory rehabilitation plan data in the auditory rehabilitation plan data recording unit 282 (step S202). The auditory rehabilitation plan data is generated based on a result of a hearing measurement performed in accordance with a generation program for generating the auditory rehabilitation plan data, which is recorded in the program recording unit 451. Specifically, to perform the user's hearing measurement, the communication control unit 46 of the communication device 4 causes the output unit 43 to sequentially output a sound volume for each predetermined sound pressure level at each predetermined frequency.

In addition, the auditory rehabilitation plan data is obtained by setting the hearing level stepwise every predetermined period toward the target hearing level (hereinafter, simply referred to as “target gain”) of the user. Specifically, the auditory rehabilitation plan data is obtained by setting a starting hearing level at the time of starting the auditory rehabilitation to a hearing level of 80% of the target gain (for example, refer to the curve L11 in FIG. 4 described above). Furthermore, the communication device 4 generates auditory rehabilitation plan data that has calculated a period taken before the target gain is reached with a daily increase of 2 dB as a predetermined period, for example (refer to the polygonal line L1 in FIG. 3 described above, for example).

The communication device 4 may generate the auditory rehabilitation plan data in consideration of at least one of the age included in the user information output from the hearing aid 2 and the presence or absence of use experience of the hearing aid 2. Specifically, the communication device 4 may determine whether the age of the user included in the user information is a predetermined age and over, for example, 80 years of age and over. When it is determined that the age of the user is the predetermined age and over, the auditory rehabilitation plan data may be generated by setting the start hearing level to a hearing level of 70% of the target gain.

Furthermore, the communication device 4 may determine whether the user has experience of using the hearing aid 2 based on whether the user has experience of using the hearing aid 2 included in the user information. Having any experience of using the hearing aid 2 means that the time period for the user to get use to the hearing aid 2 is short. Therefore, when it is determined that the user has an experience of using the hearing aid 2, the communication device 4 may generate the auditory rehabilitation plan data that sets the starting hearing level to a hearing level of 90% of the target gain.

Thereafter, the output control unit 295 outputs initial setting completion information indicating the completion of the initial setting to the charging device 3 or the communication device 4 (step S203). In this case, the display unit 44 of the communication device 4 or the display unit 31 of the charging device 3 displays the information output from the hearing aid 2. This enables the user to grasp the completion of the initial setting. After step S203, processing of the hearing aid 2 returns to the main routine in FIG. 5, and proceeds to step S103.

Returning to FIG. 5, the description of step S103 and subsequent steps will be continued.

In step S103, the determination unit 293 determines whether the user has worn the hearing aid 2. Specifically, the determination unit 293 determines whether the user has worn the hearing aid 2 by determining whether the hearing aid 2 has been removed from the charging device 3 based on an electrical connection state between the connection unit 26 and the connection unit 331 of the charging device 3. In this case, when the electrical connection state between the connection unit 26 and the connection unit 331 of the charging device 3 is disconnected, the determination unit 293 determines that the hearing aid 2 has been taken out of the charging device 3 and the user has worn the hearing aid 2. Additionally, the determination unit 293 may determine whether the user has worn the hearing aid 2 by simply determining whether the power button of the hearing aid 2 has been turned on. When the determination unit 293 has determined that the user has worn the hearing aid 2 (step S103: Yes), processing of the hearing aid 2 proceeds to step S104 described below. In contrast, when the determination unit 293 has determined that the user wears no hearing aid 2 (step S103: No), the hearing aid 2 ends the present processing.

In step S104, the acquisition unit 291 acquires: sound pressure information, being information regarding the sound to be output from the hearing aid 2 to the user and recorded by the sound pressure information recording unit 285; and the use time, being the time during which the user has used the hearing aid 2 and recorded by the use time recording unit 284.

Subsequently, the setting unit 292 sets the parameter of the hearing aid 2 based on the sound pressure information and the use time acquired by the acquisition unit 291 (step S105). Specifically, based on the sound pressure information and the use time acquired by the acquisition unit 291, and the auditory rehabilitation plan data recorded by the auditory rehabilitation plan data recording unit 282, the setting unit 292 sets the gain of the amplification amount, that is, an amount to be amplified by the signal processing unit 21 as a parameter of the hearing aid 2 to be applied onto the analog audio signal obtained by collecting the external sound by the sound collection unit 20. For example, the setting unit 292 continuously adjusts the parameter of the hearing aid 2 so that the amplification amount to be applied onto the audio signal by the signal processing unit 21 is to be set at a hearing level (for example, the curve L10 in FIG. 4) approaching the target gain for each frequency (for example, refer to the curve L11 in FIG. 4). Alternatively, the setting unit 292 may discontinuously adjust the parameter of the hearing aid 2 so that the amplification amount for the audio signal by the signal processing unit 21 is to be set at a hearing level (for example, the curve L10 in FIG. 4) approaching the target gain for each frequency and within a conversation area (for example, the region R1 in FIG. 4). With this configuration, the user can perform auditory rehabilitation under a sound pressure environment corresponding to the hearing level, namely, a hearing loss level for each user at each frequency.

Thereafter, the recording control unit 294 starts recording for accumulating (clocking) the time clocked by the clocking unit 23 in the use time recording unit 284 as the use time (step S106).

Subsequently, the recording control unit 294 starts recording for accumulating sound pressure information, being information regarding the sound to be output from the output unit 22 to the user in the sound pressure information recording unit 285 (step S107). In this case, the recording control unit 294 measures the audio signal input from the sound collection unit 20 for each frequency and each sound pressure level in the signal processing unit 21 every predetermined period, for example, every 5 msec, and performs accumulated recording of the measured information in the sound pressure information recording unit 285.

Thereafter, the determination unit 293 determines whether the user has removed the hearing aid 2 (step S108). Specifically, the determination unit 293 determines whether the user has removed the hearing aid 2 by determining whether the hearing aid 2 is housed in the charging device 3 based on the electrical connection state between the connection unit 26 and the connection unit 331 of the charging device 3. In this case, when the electrical connection state between the connection unit 26 and the connection unit 331 of the charging device 3 is turned on, the determination unit 293 determines that the hearing aid 2 is housed in the charging device 3 and the user has removed the hearing aid 2. Additionally, the determination unit 293 may determine whether the user has removed the hearing aid 2 simply by determining whether the power button of the hearing aid 2 has been turned off. When the determination unit 293 has determined that the user has removed the hearing aid 2 (step S108: Yes), processing of the hearing aid 2 proceeds to step S109 described below. In contrast, when the determination unit 293 has determined that the user has not removed the hearing aid 2 (step S108: No), processing of the hearing aid 2 proceeds to step S111 described below.

In step S109, the recording control unit 294 stops recording for accumulating the time measured by the clocking unit 23 in the use time recording unit 284 as the use time.

Subsequently, the recording control unit 294 stops the recording for accumulating the sound pressure information, being information regarding the sound to be output from the hearing aid 2 to the user in the sound pressure information recording unit 285 as the sound pressure information regarding the sound to be output from the hearing aid 2 to the user (step S110). In this case, the output control unit 295 may output the use time, the sound pressure information, the auditory rehabilitation plan data, and the current hearing level to the communication device 4 or the charging device 3 via the communication unit 27. This makes it possible for the user to grasp the situation of the auditory rehabilitation, leading to heightened motivation while preventing discontinuation of auditory rehabilitation. Additionally, the output control unit 295 may output the use time, the sound pressure information, the auditory rehabilitation plan data, and the current hearing level to a personal computer owned by an external health care professional or a device owned by a family of the user via the communication unit 27. This enables the health care professional to grasp an accurate use situation of the user and provide an appropriate follow-up to the user. After step S110, the hearing aid 2 ends the present processing.

In step S111, the determination unit 293 determines whether the use time of the user's hearing aid 2 recorded by the use time recording unit 284 is a predetermined time or more. Here, the predetermined time is a time set for each predetermined period in the auditory rehabilitation plan data. When the determination unit 293 has determined that the use time of the user's hearing aid 2 recorded by the use time recording unit 284 is a predetermined time length or more (step S111: Yes), processing of the hearing aid 2 proceeds to step S112 described below. In contrast, when the determination unit 293 has determined that the use time of the user's hearing aid 2 recorded by the use time recording unit 284 is not the predetermined time or more (step S111: No), processing of the hearing aid 2 proceeds to step S119 described below.

In step S112, the determination unit 293 determines whether the sound pressure information recorded by the sound pressure information recording unit 285 indicates a predetermined sound pressure level or more. Specifically, the determination unit 293 determines whether 30% or more of the sound pressure information recorded by the sound pressure information recording unit 285 indicates a sound pressure level of 60 dB or more. The determination unit 293 may determine whether the sound pressure information indicates 60 dB or more for each frequency in the sound pressure information recorded by the sound pressure information recording unit 285. When the determination unit 293 has determined that the sound pressure information recorded by the sound pressure information recording unit 285 indicates the predetermined sound pressure level or more (step S112: Yes), processing of the hearing aid 2 proceeds to step S113 described below. In contrast, when the determination unit 293 has determined that the sound pressure information recorded by the sound pressure information recording unit 285 does not indicate the predetermined sound pressure level or more (step S112: No), processing of the hearing aid 2 proceeds to step S114 described below.

In step S113, the setting unit 292 increases the gain with which the signal processing unit 21 amplifies the audio signal collected by the sound collection unit 20 to be equal to or more than a gain set for the next period in the auditory rehabilitation plan data. Specifically, the setting unit 292 increases the current hearing level in the auditory rehabilitation plan data to a predetermined hearing level, for example, by 3 dB in gain, and sets corrected parameter of the hearing aid 2 so as to reduce the period of the auditory rehabilitation before reaching the target hearing level. After step S113, processing of the hearing aid 2 returns to step S108 described above.

In step S114, the setting unit 292 increases the gain with which the signal processing unit 21 amplifies the audio signal collected by the sound collection unit 20 to be equal to the gain set for the next period in the auditory rehabilitation plan data. Specifically, the setting unit 292 sets the parameter of the hearing aid 2 by increasing the gain from the current hearing level to the next hearing level in the auditory rehabilitation plan data by 2 dB, for example. After step S114, processing of the hearing aid 2 returns to step S108 described above.

In step S115, the determination unit 293 determines whether the sound pressure information recorded by the sound pressure information recording unit 285 indicates a predetermined sound pressure level or more. When the determination unit 293 has determined that the sound pressure information recorded by the sound pressure information recording unit 285 indicates the predetermined sound pressure level or more (step S115: Yes), processing of the hearing aid 2 proceeds to step S114 described above. In contrast, when the determination unit 293 has determined that the sound pressure information recorded by the sound pressure information recording unit 285 does not indicate the predetermined sound pressure level or more (step S115: No), processing of the hearing aid 2 proceeds to step S116 described below.

In step S116, the determination unit 293 determines whether the current use time acquired by the acquisition unit 291 has passed a predetermined period as a target period for the setting of the current hearing level in the auditory rehabilitation plan data. When the determination unit 293 has determined that the predetermined period as a target period for the setting of the current hearing level in the auditory rehabilitation plan data has passed (step S116: Yes), processing of the hearing aid 2 proceeds to step S117 described below. In contrast, when the determination unit 293 has determined that the predetermined period as a target period for the setting of the current hearing level in the auditory rehabilitation plan data has not passed (step S116: No), processing of the hearing aid 2 proceeds to step S118 described below.

In step S117, the setting unit 292 sets the parameter of the hearing aid 2 with a corrected auditory rehabilitation period before reaching the target gain by extending the current hearing level period that has been set in the auditory rehabilitation plan data. After step S117, processing of the hearing aid 2 returns to step S108 described above.

In step S118, the setting unit 292 sets the parameter of the hearing aid 2 so that the signal processing unit 21 maintains the gain to be amplified at the current hearing level in the auditory rehabilitation plan data. After step S118, processing of the hearing aid 2 returns to step S108 described above.

According to the first embodiment described above, the setting unit 292 sets the parameter of the hearing aid 2 based on the sound pressure information and the use time acquired by the acquisition unit 291. This makes it possible to set the parameter of the hearing aid 2 optimal for the user in consideration of the magnitude of the sound actually heard by the user and the use time.

In addition, according to the first embodiment, the sound pressure information represents the magnitude of the output sound corresponding to the output signal for outputting the audio signal, which has been generated by the hearing aid 2 collecting the external sound, after being adjusted to the hearing level of the user according to the auditory rehabilitation plan. This makes it possible to set the parameter of the hearing aid 2 in consideration of use under a noisy environment.

In addition, according to the first embodiment, the magnitude of the output sound represents one of: the time accumulated for each frequency and each sound pressure level; and a sound pressure level accumulated time obtained by combining the sum of sound pressure levels for each frequency. This makes it possible to set the parameter of the hearing aid 2 for each frequency according to the environment of the use situation of the user.

In addition, according to the first embodiment, the use time is recorded as the accumulated time obtained by accumulating the time during which the user has worn the hearing aid 2, making it possible to set the parameter of the hearing aid 2 reflecting the hearing aid wearing time of the user.

Furthermore, according to the first embodiment, the setting unit 292 sets the parameter of the hearing aid 2 based on one or more of the age of the user, the presence or absence of use experience of the user using the hearing aid 2, and the state of the user, in addition to the sound pressure information, and the use time, making it possible to set parameter of the hearing aid 2 more suitable for the user.

In addition, according to the first embodiment, the determination unit 293 determines whether at least one of the sound pressure information and the use time is a predetermined value or more every predetermined period in the auditory rehabilitation plan data, and when it is determined that at least one of the sound pressure information and the use time is the predetermined value or more, the parameter of the hearing aid 2 is set to a parameter which has been changed corresponding to the next hearing level. That is, in order to prevent the hearing aid 2 from being used for a long time in a quiet environment where it is difficult to obtain an effect in the auditory rehabilitation and prevent the user from proceeding to the next hearing level, the setting unit 292 sets the parameter of the hearing aid 2 according to the sound in the environment under which the user actually uses the hearing aid 2. This makes it possible for the user to perform the hearing rehabilitation in consideration of the hearing level for each frequency according to the auditory rehabilitation plan and the actual use environment of the hearing aid 2.

Furthermore, in the first embodiment, when the determination unit 293 has determined that the user has worn the hearing aid 2, the setting unit 292 sets the parameter of the hearing aid 2 at the timing of wearing the hearing aid 2 by the user. This makes it possible to set the parameter of the hearing aid 2 optimal for the user without causing discomfort to the user.

In the first embodiment, the setting unit 292 sets the parameter of the hearing aid 2 during the time the user wears the hearing aid 2. However, the timing is not limited thereto, and the setting unit 292 may set the parameter of the hearing aid 2 when the user has housed the hearing aid 2 in the charging device 3, for example. This makes it possible to prevent the parameter of the hearing aid 2 from being changed when the user wears and uses the hearing aid 2, leading to prevention of occurrence of discomfort on the user.

In the first embodiment, the control unit 29 is provided in each of the left and right hearing aids 2R and 2L as a pair. However, the configuration is not limited thereto, and the technique is applicable to a configuration in which the control unit 29 is provided only in one of the pair. In this case, the setting unit 292 of the control unit 29 provided in one of the left and right hearing aids 2R and 2L may set the parameter of each of the left and right hearing aids 2R and 2L.

In the first embodiment, the setting unit 292 sets the left and right hearing aids 2R and 2L with the same parameter. However, the parameter setting is not limited thereto, and different parameters may be set for the left and right hearing aids 2R and 2L according to the left and right hearing levels of the user.

In addition, in the first embodiment, when the determination unit 293 has determined that the user currently wears the hearing aid 2, when a change signal for changing a parameter of the hearing aid 2 is input from the outside while the user is executing the auditory rehabilitation plan by the hearing aid 2, the setting unit 292 may prohibit the change of the parameter of the hearing aid 2 corresponding to the change signal. This makes it possible to prevent unlimited change of hearing levels in the auditory rehabilitation plan, leading to enhancement of effects of the auditory rehabilitation on the user.

### Second Embodiment

Next, a second embodiment will be described. In the first embodiment described above, the setting unit 292 sets the parameter of the hearing aid 2 based on the use time and the sound pressure information. The second embodiment performs parameter setting of the hearing aid by further adding the state of the user (for example, vital data) to the use time and the sound pressure information. In the following description, the same components as those of the hearing aid system 1 according to the first embodiment described above are denoted by the same reference numerals, and a detailed description thereof will be omitted.

### [Functional Configuration of Hearing Aid System]

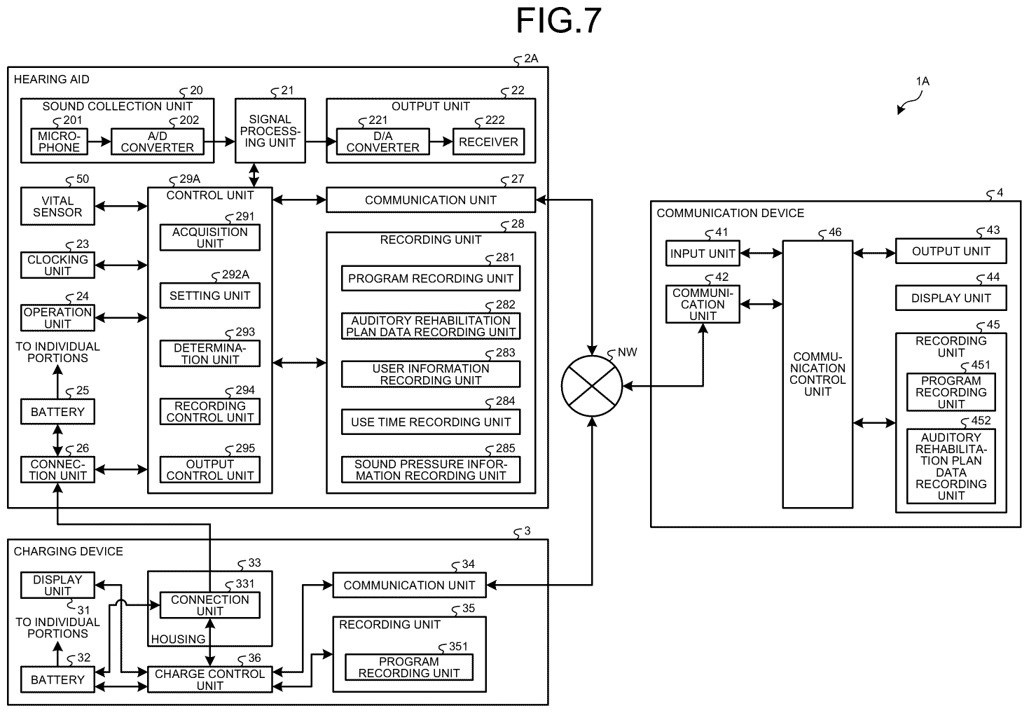

FIG. 7 is a block diagram illustrating a functional configuration of the hearing aid system according to the second embodiment. A hearing aid system 1A illustrated in FIG. 7 includes a hearing aid 2A instead of the hearing aid 2 according to the first embodiment described above. The hearing aid 2A further includes a vital sensor 50 in addition to the components of the hearing aid 2 according to the first embodiment described above. Furthermore, the hearing aid 2A further includes a control unit 29A instead of the control unit 29.

The vital sensor 50 detects the state of the user wearing the hearing aid 2 and outputs a result of the detection to the control unit 29. Here, the state of the user is represented by vital information such as a pulse, a temperature, and a heartbeat. The vital sensor 50 is constituted with a radar sensor, for example. Alternatively, the vital sensor 50 may be a pressure sensor that detects the pressure applied to the eardrum by detecting the pressure in the ear canal of the user when the user wears the hearing aid 2A. Still alternatively, the vital sensor 50 may be a sensor that detects brain waves of the user wearing the hearing aid 2A.

The control unit 29A includes a setting unit 292A instead of the setting unit 292 of the control unit 29 according to the first embodiment described above. The setting unit 292A sets the parameter of the hearing aid 2 based on the sound pressure information and the use time acquired by the acquisition unit 291 and the vital information. In the second embodiment, the control unit 29A functions as a control device.

### [Processing of Hearing Aid]

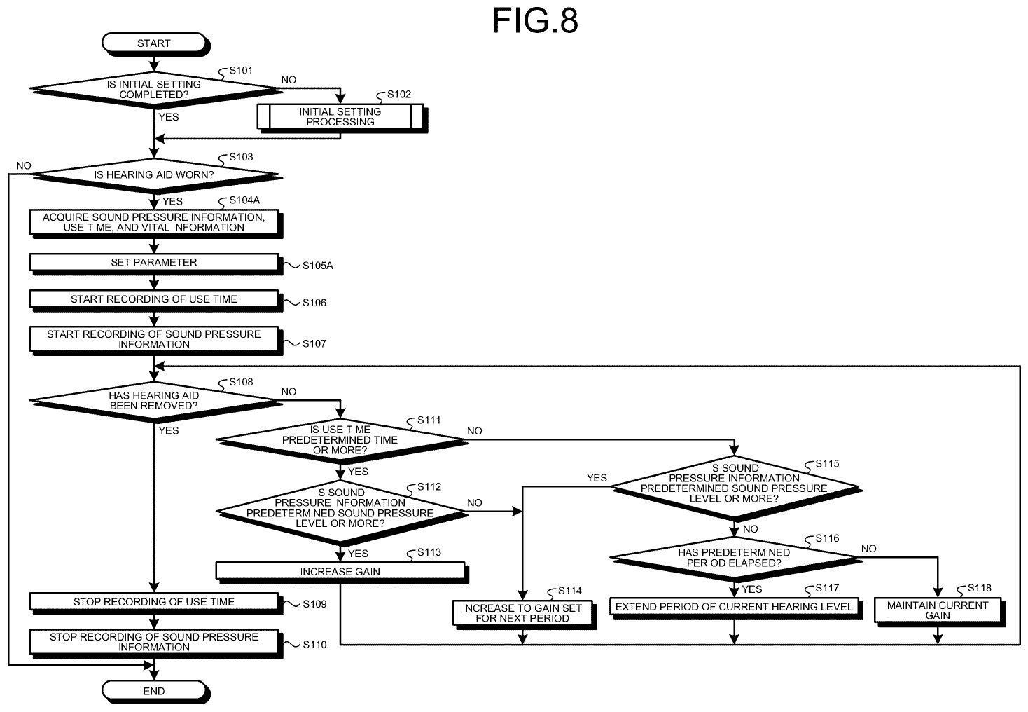

Next, processing executed by the hearing aid 2A will be described. FIG. 8 is a flowchart illustrating an outline of processing executed by the hearing aid 2A. In FIG. 8, the hearing aid 2A executes steps S104A and S105A instead of steps S104 and S105 in FIG. 5 described above. The other steps are similar to the steps in FIG. 5 described above, and thus a detailed description thereof will be omitted. Hereinafter, steps S104A and S105A executed by the hearing aid 2A will be described.

In step S104A, the acquisition unit 291 acquires: sound pressure information regarding the sound to be output from the hearing aid 2 to the user recorded by the sound pressure information recording unit 285; and the use time being the time during which the user has used the hearing aid 2 recorded by the use time recording unit 284, and vital information detected by the vital sensor 50.

Subsequently, the setting unit 292A sets the parameter of the hearing aid 2A based on the sound pressure information, the use time, and the vital information acquired by the acquisition unit 291 (step S105A). Specifically, based on the sound pressure information acquired by the acquisition unit 291, the use time, and the auditory rehabilitation plan data recorded by the auditory rehabilitation plan data recording unit 282, the setting unit 292 sets the gain to be amplified by the signal processing unit 21 as a parameter of the hearing aid 2 to be applied onto the analog audio signal obtained by collecting the external sound by the sound collection unit 20. After step S105A, processing of the hearing aid 2A proceeds to step S106.

According to the second embodiment described above, since the setting unit 292A sets the parameter of the hearing aid 2A based on the sound pressure information and use time acquired by the acquisition unit 291 and based on the vital information, it is possible to reflect the use situation and the stress state of the user.

In the second embodiment, the vital sensor 50 is provided in the hearing aid 2A, but the location of the vital sensor 50 is not limited thereto. The vital sensor 50 may be provided in a wearable terminal worn by the user, for example, a watch or glasses so as to allow the acquisition unit 291 to acquire vital information of the user via the communication unit 27. It is naturally allowable to provide the vital sensor 50 in the communication device 4, so as to cause the acquisition unit 291 to acquire the vital information of the user from the vital sensor 50 provided in the communication device 4 via the communication unit 27. Furthermore, the vital sensor 50 may be provided in a scale (not illustrated) or the like, so as to allow the acquisition unit 291 to acquire vital information of the user from the vital sensor 50 provided in the scale (not illustrated) or the like via the communication unit 27.

### Third Embodiment

Next, a third embodiment will be described. In the first embodiment described above, the setting unit 292 of the control unit 29 included in the hearing aid 2 sets the parameter of the hearing aid 2. In the third embodiment, the charge control unit of the charging device sets the parameter of the hearing aid. That is, in the third embodiment, parameter setting for the hearing aid is performed when the hearing aid is housed in the charging device. Accordingly, in the following description, the same components as those of the hearing aid system 1 according to the first embodiment described above are denoted by the same reference numerals, and a detailed description thereof will be omitted.

### [Functional Configuration of Hearing Aid System]

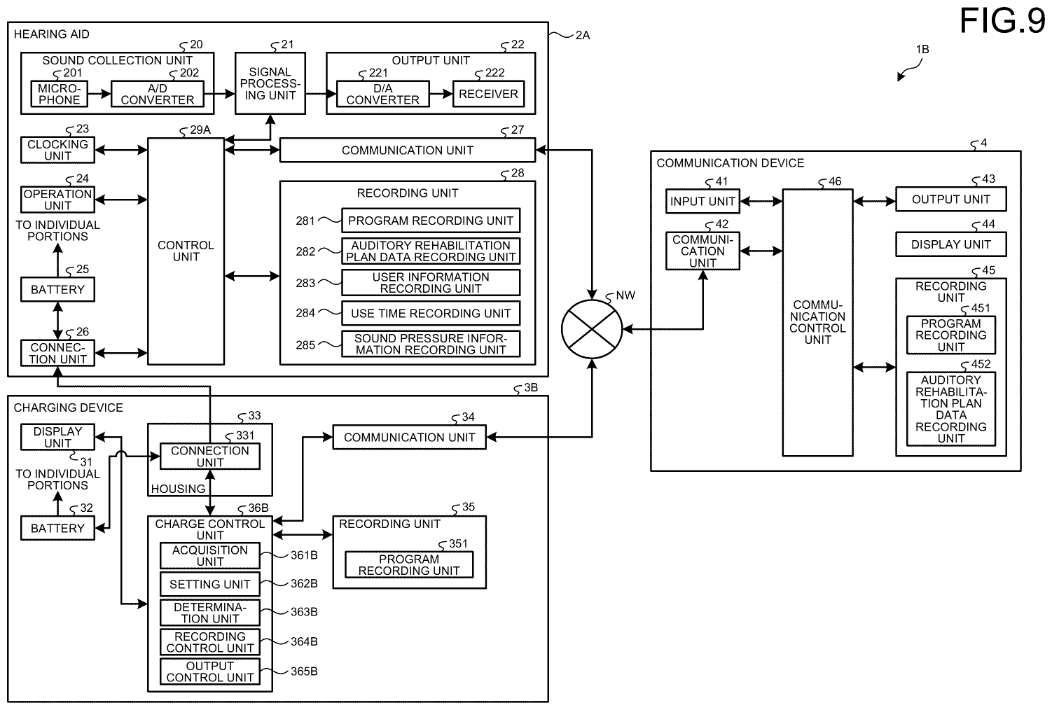

FIG. 9 is a block diagram illustrating a functional configuration of a hearing aid system according to a third embodiment. A hearing aid system 1B illustrated in FIG. 9 includes a hearing aid 2B and a charging device 3B instead of the hearing aid 2 and the charging device 3 according to the first embodiment described above.

The hearing aid 2B includes a control unit 29B instead of the control unit 29 according to the first embodiment described above. The control unit 29B omits the functions of the acquisition unit 291, the setting unit 292, the determination unit 293, the recording control unit 294, and the output control unit 295, which are included in the control unit 29 according to the above-described first embodiment.

The charging device 3B includes a charge control unit 36B instead of the charge control unit 36 of the charging device 3 according to the first embodiment described above.

The charge control unit 36B controls individual portions constituting the charging device 3. For example, when the hearing aid 2 is housed in the housing 33, the charge control unit 36 controls to supply power from the battery 32 via the connection unit 331. The charge control unit 36 is constituted with a memory and a processor having hardware devices such as a CPU or a DSP. The charge control unit 36B reads a program recorded in the program recording unit 351 onto the work area of the memory so as to execute the program, and controls each component and the like through the execution of the program by the processor, leading to cooperation of the hardware and the software to implement functional modules suitable for predetermined purposes. Specifically, the charge control unit 36B includes an acquisition unit 291B, a setting unit 292B, a determination unit 293B, a recording control unit 294B, and an output control unit 295B, having functions similar to those of each of the acquisition unit 291, the setting unit 292, the determination unit 293, the recording control unit 294, and the output control unit 29 of the output control unit 295 respectively in the hearing aid 2 in the above-described first embodiment. In the third embodiment, the charge control unit 36B functions as a control device.

### [Processing of Charging Device]

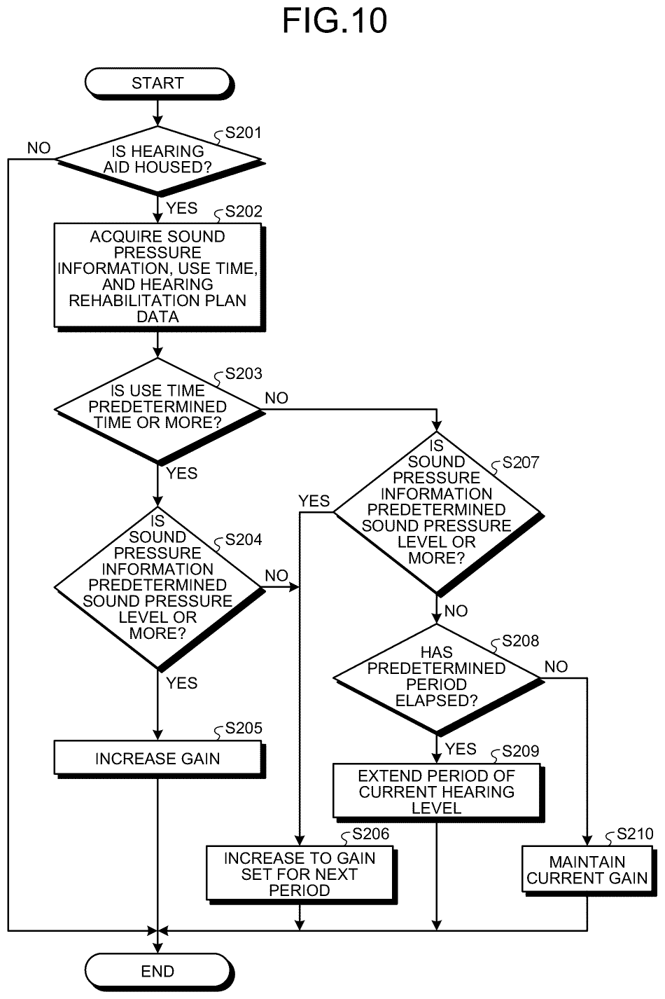

FIG. 10 is a flowchart Illustrating an outline of processing executed by the charging device 3B. As illustrated in FIG. 10, the determination unit 293B determines whether the user has housed the hearing aid 2B in the charging device 3B (step S201). Specifically, the determination unit 293B determines whether the hearing aid 2B is housed in the charging device 3B based on an electrical connection state between the connection unit 26 of the hearing aid 2B and the connection unit 331 of the charging device 3B. In this case, when the electrical connection state between the connection unit 26 of the hearing aid 2B and the connection unit 331 of the charging device 3B is a conducted state, the determination unit 293 determines that the hearing aid 2B is housed in the charging device 3B. When the determination unit 293B has determined that the hearing aid 2B is housed in the charging device 3B (step S201: Yes), processing of the charging device 3B proceeds to step S202 described below. In contrast, when the determination unit 293B has determined that the hearing aid 2B is not housed in the charging device 3B (step S201: No), the charging device 3B ends the present processing.

In step S202, the acquisition unit 291B acquires the use time from the use time recording unit 284 of the hearing aid 2B, the sound pressure information from the sound pressure information recording unit 285, and the auditory rehabilitation plan data from the auditory rehabilitation plan data recording unit 282 via the connection unit 331.

Subsequently, the determination unit 293B determines whether the use time of the hearing aid 2B of the user acquired by the acquisition unit 291B from the hearing aid 2B is a predetermined time or more (step S203). When the determination unit 293B has determined that the use time of the hearing aid 2B of the user acquired by the acquisition unit 291B from the hearing aid 2B is the predetermined time or more (step S203: Yes), processing of the charging device 3B proceeds to step S204 described below. In contrast, when the determination unit 293B has determined that the use time of the hearing aid 2B of the user acquired by the acquisition unit 291B from the hearing aid 2B is not the predetermined time or more (step S203: No), processing of the charging device 3B proceeds to step S207 described below.

In step S204, the determination unit 293B determines whether the sound pressure information acquired by the acquisition unit 291B from the hearing aid 2B is a predetermined sound pressure level or more. Specifically, the determination unit 293 determines whether 30% or more of the sound pressure information acquired by the acquisition unit 291B from the hearing aid 2B is at a sound pressure level of 60 dB or more. Note that the determination unit 293B may determine whether the sound pressure information acquired by the acquisition unit 291B from the hearing aid 2B is 60 dB or more for each frequency. When the determination unit 293B has determined that the sound pressure information acquired by the acquisition unit 291B from the hearing aid 2B is the predetermined sound pressure level or more (step S204: Yes), processing of the charging device 3B proceeds to step S205 described below. In contrast, when the determination unit 293B has determined that the sound pressure information acquired by the acquisition unit 291B from the hearing aid 2B is not the predetermined sound pressure level or more (step S204: No), processing of the charging device 3B proceeds to step S206 described below.

In step S205, the setting unit 292B increases the gain with which the signal processing unit 21 of the hearing aid 2B amplifies the audio signal collected by the sound collection unit 20 to be equal to or more than a gain set for the next period in the auditory rehabilitation plan data. Specifically, the setting unit 292B increases the current hearing level in the auditory rehabilitation plan data to a predetermined hearing level, for example, by 3 dB in gain, and sets corrected parameter of the hearing aid 2B so as to reduce the period of the auditory rehabilitation before reaching the target hearing level. In this case, the output control unit 295B outputs the parameter of the hearing aid 2B set by the setting unit 292B via the connection unit 331. With this configuration, the hearing aid 2B can amplify and output the audio signal with the parameter of the auditory rehabilitation plan suitable for the user each time the hearing aid 2B is housed in the charging device 3B. After step S205, the charging device 3B ends the present processing.

In step S206, the setting unit 292B increases the gain with which the signal processing unit 21 amplifies the audio signal collected by the sound collection unit 20 to be equal to the gain set for the next period in the auditory rehabilitation plan data. Specifically, the setting unit 292B sets the parameter of the hearing aid 2 by increasing the gain from the current hearing level to the next hearing level in the auditory rehabilitation plan data by 2 dB, for example. In this case, the output control unit 295B outputs the parameter of the hearing aid 2B set by the setting unit 292B via the connection unit 331. With this configuration, the hearing aid 2B can amplify and output the audio signal with the parameter of the auditory rehabilitation plan suitable for the user each time the hearing aid 2B is housed in the charging device 3B. After step S206, the charging device 3B ends the present processing.

In step S207, the determination unit 293 determines whether the sound pressure information acquired by the acquisition unit 291B from the hearing aid 2B is a predetermined sound pressure level or more. When the determination unit 293 has determined that the sound pressure information acquired by the acquisition unit 291B from the hearing aid 2B is the predetermined sound pressure level or more (step S207: Yes), processing of the hearing aid 2 proceeds to step S205 described above. In contrast, when the determination unit 293 has determined that the sound pressure information acquired by the acquisition unit 291B from the hearing aid 2B is not the predetermined sound pressure level or more (step S207: No), processing of the hearing aid 2 proceeds to step S208 described below.

In step S208, the determination unit 293B determines whether the current hearing level in the auditory rehabilitation plan data acquired by the acquisition unit 291B from the hearing aid 2B has passed a set predetermined period. When the determination unit 293B has determined that the current hearing level in the auditory rehabilitation plan data has passed the set predetermined period (step S208: Yes), processing of the charging device 3B proceeds to step S209 described below. In contrast, when the determination unit 293B has determined that the current hearing level in the auditory rehabilitation plan data has not passed the set predetermined period (step S208: No), processing of the charging device 3B proceeds to step S210 described below.

In step S209, the setting unit 292B sets the parameter of the hearing aid 2B with a corrected auditory rehabilitation period before reaching the target gain by extending the current hearing level period that has been set in the auditory rehabilitation plan data. In this case, the output control unit 295B outputs the parameter of the hearing aid 2B set by the setting unit 292B via the connection unit 331. With this configuration, the hearing aid 2B can amplify and output the audio signal with the parameter of the auditory rehabilitation plan according to the degree of wearing of the hearing aid 2B on the user. After step S209, the charging device 3B ends the present processing.

In step S210, the setting unit 292B sets the parameter of the hearing aid 2 so that the signal processing unit 21 maintains the gain to be amplified at the current hearing level in the auditory rehabilitation plan data. In this case, the output control unit 295B outputs the parameter of the hearing aid 2B set by the setting unit 292B via the connection unit 331. With this configuration, the hearing aid 2B can amplify and output the audio signal with the parameter of the auditory rehabilitation plan according to the degree of hearing level of the user. The charging device 3B ends the present processing.

According to the third embodiment described above, similarly to the first embodiment, it is possible to set the parameter of the hearing aid 2B optimal for the user.

Furthermore, in the third embodiment, the setting unit 292B sets the parameter of the hearing aid 2B during the time when the user houses the hearing aid 2B in the charging device 3B. Therefore, it is possible to prevent the parameter of the hearing aid 2B from being changed when the user wears the hearing aid 2B to use, making it possible to prevent occurrence of discomfort on the user.

In addition, in the third embodiment, the acquisition unit 291B acquires the sound pressure information and the use time from the hearing aid 2B every time the hearing aid 2B is housed in the charging device 3B. This can reduce the recording capacity of the recording unit 28 of the hearing aid 2B, making it possible to downsize that the hearing aid 2B compared to the hearing aid 2 according to the first embodiment.

In addition, in the third embodiment, the setting unit 292B sets the parameter of the hearing aid 2B during the time when the user houses the hearing aid 2B in the charging device 3B. This makes it possible to reduce the processing capacity of the control unit 29B of the hearing aid 2B, leading to downsizing of the hearing aid 2B.

### Modification of First to Third Embodiments

Next, a modification of the first to third embodiments will be described. Although the hearing aid according to the first embodiment described above is an air conduction in-ear type in which a pair of right and left hearing aids, the present invention is not limited thereto, and the hearing aid may be a pair of left and right behind-the-ear type hearing aid.

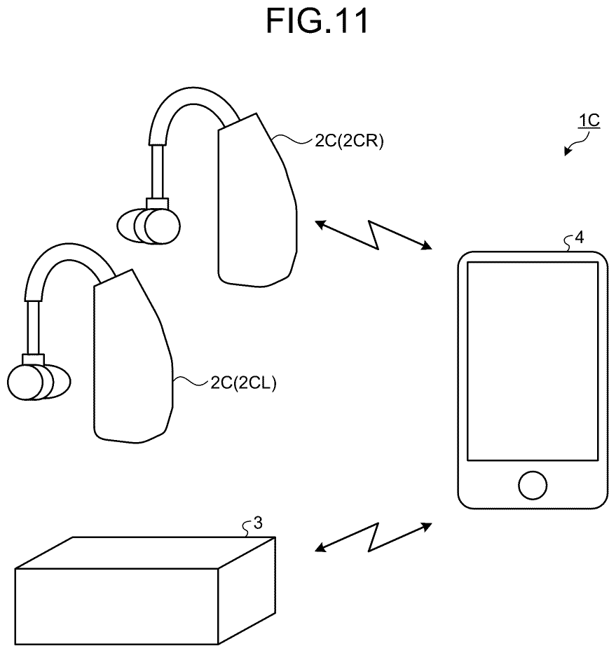

FIG. 11 is a diagram illustrating a schematic configuration of a hearing aid system according to a modification of the first to third embodiments. A hearing aid system 1C illustrated in FIG. 11 includes a hearing aid 2C instead of the hearing aid 2 according to the first embodiment described above. The hearing aid 2C is a pair of left and right (2CR and 2CL) air conduction behind-the-ear type hearing aid. Since the hearing aid 2C has a function similar to that of the hearing aid 2 according to the first embodiment described above, a detailed description of the configuration will be omitted.

According to the modification 1 of the first to third embodiments described above, the effects similar to those of the first to third embodiments described above are obtained.

### Other Embodiments

Various inventions can be formed by appropriately combining a plurality of components disclosed in the hearing aid system according to the first to third embodiments of the present disclosure described above. For example, some components may be deleted from all the components described in the hearing aid system according to the first to third embodiments of the present disclosure described above. Furthermore, the components described in the hearing aid system according to the first to third embodiments described above may be appropriately combined with each other.

Furthermore, in the hearing aid system according to the first to third embodiments of the present disclosure, the control unit of the hearing aid may acquire the use time during which the user has used the hearing aid and the use situation of the hearing aid, and may set the parameter of the hearing aid in the auditory rehabilitation plan of the user based on the acquired use time and use situation. Here, the use situation is at least one of sound pressure information and user state information. Here, an example of the user state information is vital information. This makes it possible to set the parameter of the hearing aid according to a situation in which the user actually uses the hearing aid.

Furthermore, in the hearing aid system according to the first to third embodiments of the present disclosure, it is allowable to provide the communication control unit 46 of the communication device 4 with functions of the acquisition unit 291, the setting unit 292, the determination unit 293, the recording control unit 294, and the output control unit 295 so as to function as the control device of the present disclosure.

In addition, in the hearing aid system according to the first to third embodiments of the present disclosure, the above-described “unit” can be read as “means”, “circuit”, or the like. For example, the control unit can be read as a control means or a control circuit.

In addition, the program to be executed by the hearing aid system according to the first to third embodiments of the present disclosure is provided by being recorded in a computer-readable recording medium such as a CD-ROM, a flexible disk (FD), a CD-R, a digital versatile disk (DVD), a USB medium, or flash memory as file data in an installable format or an executable format.

Furthermore, the program executed by the hearing aid system according to the first to third embodiments of the present disclosure may be stored on a computer connected to a network such as the Internet and provided by being downloaded via the network.

In the description of the flowcharts in the present specification, the order of processing between steps is clearly indicated using expressions such as “first”, “thereafter”, or “subsequently”. However, the order of processing necessary for implementing the present invention is not to be uniquely determined by these expressions. That is, the order of processing in the flowcharts described in the present specification can be changed within a range without inconsistency.

While some of the embodiments of the present application have been described in detail with reference to the drawings, these are merely examples. The present disclosure can be implemented in other forms subjected to various modifications and improvements based on the knowledge of those skilled in the art, including the aspects described in the present disclosure.

Note that the present technique can also have the following configurations.
(1) A control device comprising:
   an acquisition unit that acquires sound pressure information and use time, the sound pressure information being information regarding a sound to be output from a hearing aid to a predetermined user, the use time being a time during which the predetermined user has used the hearing aid; and
   a setting unit that sets a parameter of the hearing aid in an auditory rehabilitation plan of the predetermined user based on the sound pressure information and the use time.
(2) The control device according to (1), wherein
   the sound pressure information
   represents a magnitude of an output sound corresponding to an output signal for adjusting an audio signal generated by the hearing aid collecting an external sound to a hearing level of the predetermined user according to the auditory rehabilitation plan and outputting the adjusted audio signal.
(3) The control device according to (2), wherein
   the magnitude of the output sound
   corresponds to any one of: a time accumulated for each frequency and each sound pressure level; and a sound pressure level accumulated time obtained by combining a sum of sound pressure levels for each frequency.
(4) The control device according to any one of (1) to (3), wherein
   the use time
   represents an accumulated time obtained by accumulating a time during which the predetermined user wears the hearing aid.
(5) The control device according to any one of (1) to (4), wherein
   the acquisition unit
   acquires any one or more of an age of the predetermined user, presence or absence of use experience of the predetermined user using the hearing aid, and a state of the predetermined user, and
   the setting unit
   sets the parameter based on any one or more of the age of the predetermined user, the presence or absence of use experience of the predetermined user using the hearing aid, and the state of the predetermined user, and based on the sound pressure information and the use time.
(6) The control device according to any one of (1) to (5), further comprising
   a determination unit that determines the sound pressure information and the use time, wherein
   the auditory rehabilitation plan
   is a plan in which a hearing level is set every predetermined period toward a target hearing level of the predetermined user,
   the determination unit
   determines whether at least one of the sound pressure information and the use time is a predetermined value or more every predetermined period, and
   the setting unit,
   when the determination unit has determined that at least one of the sound pressure information and the use time is the predetermined value or more, sets the parameter to be changed to a parameter corresponding to a next hearing level.
(7) The control device according to (2), further comprising
   a determination unit that determines the sound pressure information and the use time, wherein
   the auditory rehabilitation plan
   is a plan in which the hearing level is set every predetermined period toward a target hearing level of the predetermined user,
   the determination unit
   determines whether the use time is a predetermined time or more every predetermined period, and determines whether the sound pressure information is a predetermined sound pressure level or more every predetermined period, and
   the setting unit,
   when the determination unit has determined that the use time is the predetermined time or more and the determination unit has determined that the sound pressure information is a predetermined sound pressure level or more, sets the parameter to allow the hearing level to be increased by a gain greater than or equal to a gain for the audio signal set for a next period in the auditory rehabilitation plan,
   when the determination unit has determined that the use time is the predetermined time or more and the determination unit has determined that the sound pressure information is not a predetermined sound pressure level or more, sets the parameter to allow the hearing level to be increased to a gain for the audio signal set for the next period in the auditory rehabilitation plan,
   when the determination unit has determined that the use time is not the predetermined time or more and the determination unit has determined that the sound pressure information is a predetermined sound pressure level or more, sets the parameter to allow the hearing level to be increased to the gain for the audio signal set for the next period in the auditory rehabilitation plan, and
   when the determination unit has determined that the use time is not the predetermined time or more and the determination unit has determined that the sound pressure information is not a predetermined sound pressure level or more, sets the parameter to allow the hearing level to maintain a gain for the audio signal set for a current period in the auditory rehabilitation plan.
(8) The control device according to any one of (1) to (7), further comprising
   a determination unit that determines whether the predetermined user currently wears the hearing aid, wherein
   the acquisition unit
   acquires a wearing state of the hearing aid by the predetermined user,
   the determination unit
   determines whether the predetermined user currently wears the hearing aid based on the wearing state, and
   the setting unit
   sets the parameter when the determination unit has determined that the predetermined user does not currently wear the hearing aid.
(9) The control device according to (8), wherein
   the setting unit
   sets the parameter at a timing of wearing the hearing aid by the predetermined user.
(10) The control device according to any one of (1) to (7), further comprising
   a determination unit that determines whether the predetermined user has worn the hearing aid, wherein
   the acquisition unit
   acquires a wearing state of the hearing aid by the predetermined user,
   the determination unit
   determines whether the predetermined user has worn the hearing aid based on the wearing state, and
   the setting unit
   sets the parameter when the determination unit has determined that the predetermined user has not worn the hearing aid.
(11) The control device according to (8) or (9), wherein
   the setting unit,
   when a change signal for changing a parameter of the hearing aid is input from an outside while the predetermined user is executing the auditory rehabilitation plan using the hearing aid when the determination unit has determined that the predetermined user currently wears the hearing aid, prohibits a change of the parameter corresponding to the change signal.
(12) The control device according to any one of (1) to (11), further comprising
   an output control unit that outputs the parameter and the auditory rehabilitation plan to any one of a communication device associated with the hearing aid, and a charging device that charges the hearing aid.
(13) A control device comprising:
   an acquisition unit that acquires a use time during which a predetermined user has used a hearing aid and a use situation of the hearing aid; and
   a setting unit that sets a parameter of the hearing aid in an auditory rehabilitation plan of the predetermined user based on the use time and the use situation.
(14) A hearing aid comprising:
   the control device according to any one of (1) to (12);
   a sound collection unit that collects an external sound and generates an audio signal;
   a signal processing unit that amplifies the audio signal; and
   an output unit that outputs a sound corresponding to the audio signal amplified by the signal processing unit, wherein
   the setting unit
   sets a gain applied by the signal processing unit for the audio signal, as the parameter.
(15) The hearing aid according to (14), further comprising
   a clocking unit that clocks a wearing time during which the predetermined user has worn the hearing aid, wherein
   the control device further includes
   a recording control unit that accumulates and records the wearing time in a recording unit as the use time, and accumulates and records the sound sequentially output by the output unit in the recording unit as the sound pressure information.
(16) A charging device comprising:
   the control device according to any one of (1) to (12); and
   a housing capable of housing the hearing aid and configured to charge the hearing aid.
(17) The charging device according to (16), wherein
   the control device further includes:
   a determination unit that determines whether the hearing aid is housed in the housing; and
   a recording control unit that accumulates and records the sound pressure information and the use time in a recording unit,
   the acquisition unit,
   when the determination unit has determined that the hearing aid is housed in the housing, acquires the sound pressure information and the use time recorded in the hearing aid, and
   the recording control unit
   accumulates and records the sound pressure information and the use time acquired by the acquisition unit from the hearing aid, in the recording unit.
(18) The charging device according to (16), wherein
   the control device further includes
   a determination unit that determines whether the hearing aid has been removed from the housing, and
   the acquisition unit,
   when the determination unit has determined that the hearing aid has been removed from the housing, acquires a time ranging from a time point of removal of the hearing aid from the housing to a time point of storage of the hearing aid in the housing, as the use time.
(19) A hearing aid system comprising:
   a hearing aid that can be worn by a predetermined user;
   a charging device capable of housing the hearing aid and capable of charging the hearing aid;
   a communication device that is communicable with at least either one of the hearing aid or the charging device and generates auditory rehabilitation plan data of the predetermined user and outputs the generated auditory rehabilitation plan data to either the hearing aid or the charging device; and
   a control device that controls performance of the hearing aid, wherein
   the control device
   is provided in any of the hearing aid, the charging device, and the communication device, and
   the control device includes:
   an acquisition unit that acquires sound pressure information and a use time, the sound pressure information being information regarding a sound to be output from the hearing aid to the predetermined user, the use time being a time during which the predetermined user has used the hearing aid; and
   a setting unit that sets a parameter of the hearing aid in an auditory rehabilitation plan of the predetermined user based on the sound pressure information and the use time.
(20) A program to be executed by a control device, the control device including a processor and configured to control performance of a hearing aid,
   the program causing the processor to execute processing including:
   acquiring sound pressure information and use time, the sound pressure information being information regarding a sound to be output from the hearing aid to a predetermined user, the use time being a time during which the predetermined user has used the hearing aid; and
   setting a parameter of the hearing aid in an auditory rehabilitation plan of the predetermined user based on the sound pressure information and the use time.
(21) A control method to be executed by a control device, the control device including a processor and configured to control performance of a hearing aid,
   the method comprising:
   by the processor,
   acquiring sound pressure information and use time, the sound pressure information being information regarding a sound to be output from the hearing aid to a predetermined user, the use time being a time during which the predetermined user has used the hearing aid; and
   setting a parameter of the hearing aid in an auditory rehabilitation plan of the predetermined user based on the sound pressure information and the use time.

### REFERENCE SIGNS LIST

1, 1A, 1B, 1C HEARING AID SYSTEM
2, 2A, 2B, 2C HEARING AID
3, 3B CHARGING DEVICE
4 COMMUNICATION DEVICE
20 SOUND COLLECTION UNIT
21 SIGNAL PROCESSING UNIT
22, 43 OUTPUT UNIT
23 CLOCKING UNIT
24 OPERATION UNIT
25, 32 BATTERY
26, 331 CONNECTION UNIT
27, 34, 42 COMMUNICATION UNIT
28, 35, 45 RECORDING UNIT
29, 29A, 29B CONTROL UNIT
31, 44 DISPLAY UNIT
33 HOUSING
36, 36B CHARGE CONTROL UNIT
41 INPUT UNIT
46 COMMUNICATION CONTROL UNIT
50 VITAL SENSOR
201 MICROPHONE
202 A/D CONVERTER
221 D/A CONVERTER
222 RECEIVER
281, 351, 451 PROGRAM RECORDING UNIT
282, 452 AUDITORY REHABILITATION PLAN DATA RECORDING UNIT
283 USER INFORMATION RECORDING UNIT
284 USE TIME RECORDING UNIT
285 SOUND PRESSURE INFORMATION RECORDING UNIT
291, 291B ACQUISITION UNIT
292, 292A, 292B SETTING UNIT
293, 293B DETERMINATION UNIT
294, 294B RECORDING CONTROL UNIT
295, 295B OUTPUT CONTROL UNIT

1: A control device comprising:
an acquisition unit that acquires sound pressure information and use time, the sound pressure information being information regarding a sound to be output from a hearing aid to a predetermined user, the use time being a time during which the predetermined user has used the hearing aid; and
a setting unit that sets a parameter of the hearing aid in an auditory rehabilitation plan of the predetermined user based on the sound pressure information and the use time.

2: The control device according to claim 1, wherein
the sound pressure information
represents a magnitude of an output sound corresponding to an output signal for adjusting an audio signal generated by the hearing aid collecting an external sound to a hearing level of the predetermined user according to the auditory rehabilitation plan and outputting the adjusted audio signal.

3: The control device according to claim 2, wherein
the magnitude of the output sound
corresponds to any one of: a time accumulated for each frequency and each sound pressure level; and a sound pressure level accumulated time obtained by combining a sum of sound pressure levels for each frequency.

4: The control device according to claim 1, wherein
the use time
represents an accumulated time obtained by accumulating a time during which the predetermined user wears the hearing aid.

5: The control device according to claim 1, wherein
the acquisition unit
acquires any one or more of an age of the predetermined user, presence or absence of use experience of the predetermined user using the hearing aid, and a state of the predetermined user, and
the setting unit
sets the parameter based on any one or more of the age of the predetermined user, the presence or absence of use experience of the predetermined user using the hearing aid, and the state of the predetermined user, and based on the sound pressure information and the use time.

6: The control device according to claim 1, further comprising
a determination unit that determines the sound pressure information and the use time, wherein
the auditory rehabilitation plan
is a plan in which a hearing level is set every predetermined period toward a target hearing level of the predetermined user,
the determination unit
determines whether at least one of the sound pressure information and the use time is a predetermined value or more every predetermined period, and
the setting unit,
when the determination unit has determined that at least one of the sound pressure information and the use time is the predetermined value or more, sets the parameter to be changed to a parameter corresponding to a next hearing level.

7: The control device according to claim 2, further comprising
a determination unit that determines the sound pressure information and the use time, wherein
the auditory rehabilitation plan
is a plan in which the hearing level is set every predetermined period toward a target hearing level of the predetermined user,
the determination unit
determines whether the use time is a predetermined time or more every predetermined period, and determines whether the sound pressure information is a predetermined sound pressure level or more every predetermined period, and
the setting unit,
when the determination unit has determined that the use time is the predetermined time or more and the determination unit has determined that the sound pressure information is a predetermined sound pressure level or more, sets the parameter to allow the hearing level to be increased by a gain greater than or equal to a gain for the audio signal set for a next period in the auditory rehabilitation plan,
when the determination unit has determined that the use time is the predetermined time or more and the determination unit has determined that the sound pressure information is not a predetermined sound pressure level or more, sets the parameter to allow the hearing level to be increased to a gain for the audio signal set for the next period in the auditory rehabilitation plan,
when the determination unit has determined that the use time is not the predetermined time or more and the determination unit has determined that the sound pressure information is a predetermined sound pressure level or more, sets the parameter to allow the hearing level to be increased to the gain for the audio signal set for the next period in the auditory rehabilitation plan, and
when the determination unit has determined that the use time is not the predetermined time or more and the determination unit has determined that the sound pressure information is not a predetermined sound pressure level or more, sets the parameter to allow the hearing level to maintain a gain for the audio signal set for a current period in the auditory rehabilitation plan.

8: The control device according to claim 1, further comprising
a determination unit that determines whether the predetermined user currently wears the hearing aid, wherein
the acquisition unit
acquires a wearing state of the hearing aid by the predetermined user,
the determination unit
determines whether the predetermined user currently wears the hearing aid based on the wearing state, and
the setting unit
sets the parameter when the determination unit has determined that the predetermined user does not currently wear the hearing aid.

9: The control device according to claim 8, wherein
the setting unit
sets the parameter at a timing of wearing the hearing aid by the predetermined user.

10: The control device according to claim 8, wherein
the setting unit,
when a change signal for changing a parameter of the hearing aid is input from an outside while the predetermined user is executing the auditory rehabilitation plan using the hearing aid when the determination unit has determined that the predetermined user currently wears the hearing aid, prohibits a change of the parameter corresponding to the change signal.

11: The control device according to claim 1, further comprising
an output control unit that outputs the parameter and the auditory rehabilitation plan to any one of a communication device associated with the hearing aid, and a charging device that charges the hearing aid.

12: A control device comprising:
an acquisition unit that acquires a use time during which a predetermined user has used a hearing aid and a use situation of the hearing aid; and
a setting unit that sets a parameter of the hearing aid in an auditory rehabilitation plan of the predetermined user based on the use time and the use situation.

13: A hearing aid comprising:
the control device according to claim 1;
a sound collection unit that collects an external sound and generates an audio signal;
a signal processing unit that amplifies the audio signal; and
an output unit that outputs a sound corresponding to the audio signal amplified by the signal processing unit, wherein
the setting unit
sets a gain applied by the signal processing unit for the audio signal, as the parameter.

14: The hearing aid according to claim 13, further comprising
a clocking unit that clocks a wearing time during which the predetermined user has worn the hearing aid, wherein
the control device further includes
a recording control unit that accumulates and records the wearing time in a recording unit as the use time, and accumulates and records the sound sequentially output by the output unit in the recording unit as the sound pressure information.

15: A charging device comprising:
the control device according to claim 1; and
a housing capable of housing the hearing aid and configured to charge the hearing aid.

16: The charging device according to claim 15, wherein
the control device further includes:
a determination unit that determines whether the hearing aid is housed in the housing; and
a recording control unit that accumulates and records the sound pressure information and the use time in a recording unit,
the acquisition unit,
when the determination unit has determined that the hearing aid is housed in the housing, acquires the sound pressure information and the use time recorded in the hearing aid, and
the recording control unit
accumulates and records the sound pressure information and the use time acquired by the acquisition unit from the hearing aid, in the recording unit.

17: The charging device according to claim 15, wherein
the control device further includes
a determination unit that determines whether the hearing aid has been removed from the housing, and
the acquisition unit,
when the determination unit has determined that the hearing aid has been removed from the housing, acquires a time ranging from a time point of removal of the hearing aid from the housing to a time point of storage of the hearing aid in the housing, as the use time.

18: A hearing aid system comprising:
a hearing aid that can be worn by a predetermined user;
a charging device capable of housing the hearing aid and capable of charging the hearing aid;
a communication device that is communicable with at least either one of the hearing aid or the charging device and generates auditory rehabilitation plan data of the predetermined user and outputs the generated auditory rehabilitation plan data to either the hearing aid or the charging device; and
a control device that controls performance of the hearing aid, wherein
the control device
is provided in any of the hearing aid, the charging device, and the communication device, and
the control device includes:
an acquisition unit that acquires sound pressure information and a use time, the sound pressure information being information regarding a sound to be output from the hearing aid to the predetermined user, the use time being a time during which the predetermined user has used the hearing aid; and
a setting unit that sets a parameter of the hearing aid in an auditory rehabilitation plan of the predetermined user based on the sound pressure information and the use time.

19-20. (canceled)
